(19) United States
(12) Patent Application Publication
(10) Pub. No.: US 2017/0037812 A1
(43) Pub. Date: Feb. 9, 2017

(54) THERMAL ENGINE WITH ENERGY MODULATION MECHANISM

(71) Applicant: Da Wei HUANG, Westmead, New South Wales (AU)

(72) Inventor: Da Wei Huang, Sydney, New South Wales (AU)

(21) Appl. No.: 15/303,770

(22) PCT Filed: Apr. 8, 2015
(86) PCT No.: PCT/AU2015/050159

§ 371 Date: Oct. 14, 2016

(30) Foreign Application Priority Data
Apr. 14, 2014 (AU) 2014901349

(51) Int. Cl. F02G 1/05; F02G 1/055

(52) U.S. Cl. CPC F02G 1/05; F02G 1/055; F02G 2270/90

(57) ABSTRACT

Disclosed herein is an apparatus for extracting thermal energy from thermal expansion of a working medium in the apparatus. The apparatus includes a thermal expander, a compressor for compressing the working medium after the expansion, and a force modulation unit connecting the thermal expander to the compressor. The force modulation unit consists of two conversion gears that are connected by a lever system. The lever system can be dynamically controlled so that the non-constant force from thermal expansion is modulated into a substantially constant output force of the apparatus.

### TECHNICAL FIELD

The present invention relates to thermal engines. More particularly, the invention relates to a thermal engine that converts thermal energy into mechanical energy, having an energy modulation mechanism to utilize thermal energy more efficiently.

### BACKGROUND ART

Conventional thermal engine designs do not have careful consideration on the characteristics of thermal energy behavior, especially its energy distribution during expansion and compression. Although it has been observed that gas expansion energy is a non-constant force, the non-constant energy is used in all prior art thermal engines.

Another existing issue with thermal engines is how to convert reciprocation motion of the pistons into rotary motion efficiently. A crankshaft is conventionally used to convert reciprocation motion into rotary motion. Though, crankshaft and other conventional solutions are inefficient. Following equation illustrates the relationship of piston head instantaneous force versus final torque force.

T=Fsinα(L²−(rsinα)²)+rcas\sqrt{L²−(rsin)²}/L² (Equation for crankshaft efficiency)

The problem multiplies as compression of gaseous working fluid also relies on crankshaft, which will further draw more energy from the expansion. In an internal combustion engine, fresh air needs compression before injection of fuel. The compression force is part of expansion force from other cylinders that have fuel combusted and expand against piston. The pistons movement further needs crankshaft to pass the torque. Therefore, as the result, the compression needs more energy from the expansion because of crankshaft inefficiency.

### SUMMARY OF INVENTION

One embodiment provides an apparatus for extracting thermal energy including at least one expander for extracting thermal energy from thermal expansion of a working medium in one or more cylinders of the at least one expander, at least one compressor for compressing the working medium after the expansion, and a force modulation unit connecting the at least one expander to the at least one compressor, the force modulation unit being adapted to modulate non-constant force from the at least one expander into a substantially constant force.

In an embodiment, the at least one expander and the at least one compressor work alternately via the force modulation unit.

In an embodiment, the force modulating unit includes two conversion gears, each conversion gear having at least one epicyclic gear. The force modulating unit further includes a lever connecting the two conversion gears. Each conversion gear acts on the lever alternately for each cycle of expansion and/or compression.

In an embodiment, the lever constrains a sun gear axis and a planetary gear axis of each epicyclic gear within a swinging plane. The fulcrum of the lever is also constrained by the swinging plane. The fulcrum is freely slideable along the lever in between the planetary gear axes of the conversion gears for pivotal control. An expansion force from the at least one expander acts on the lever via the epicyclic gears of each conversion gear, through the planetary shaft axis constrained by the swinging plane, perpendicularly against the lever in real time when it is swinging around its sun gear.

In an embodiment, the lever is adapted to modulate gas expansion force or gas compression force through a dynamic leverage ratio control in a range of smaller than infinitive and bigger than inversely infinitive. The fulcrum of the lever is further dynamically controlled by a stepper motor.

In an embodiment, the energy level in a first conversion gear resulting from thermal expansion is offset by the energy level in a second conversion gear using the dynamic leverage control of the lever, with a constant surplus output during each cycle. In addition, a deficiency in thermal expansion pressure can be compensated by thermal radiation from an external heat source. Furthermore, compression entropy can be reduced by thermal radiation towards low temperature uncompressed working medium.

In an embodiment, the apparatus further includes at least one cryogenic expander. The at least one cryogenic expander is used to cool temperature of the working medium between end of thermal expansion and intake of working medium by the compressor. Working medium ejected by the at least one cryogenic expander can be used to cool temperature of the working medium between end of thermal expansion and intake of working medium by the at least one compressor. In addition, working medium ejected by the at least one cryogenic expander can be used to control temperature of high pressure working medium before intake by the at least one expander.

In an embodiment, piston displacement in one side of the at least one expander due to working medium expansion, is converted into rotary motion by the epicyclic gear of each conversion gear in the force modulation unit. The lever, through its fulcrum, delivers a reversal and leveraged action force to overcome compression force, ejection of working medium after expansion and a net output force that is constant for the cycle.

In an embodiment, the apparatus further includes a torque coupling mechanism for coupling torque force from the rotary motion provided by each conversion gear. The torque coupling mechanism includes two epicyclic gears adapted to selectively collect the torque force provided by the two epicyclic gears of the conversion gears.

In an embodiment, the apparatus further includes a differential unit adapted to combine two torque forces collected by the torque coupling mechanism into one directional torque output.

In an embodiment, the apparatus further includes a continuously variable transmission unit adapted to change an output ratio of the apparatus. The continuously variable transmission unit includes a first axis and a second axis within a plane and perpendicular to one another, the first axis having an input master friction wheel and slave friction wheel rotating around it due to another pair of friction wheels sandwiching the master and slave wheels with pressure while rotating around the second axis to allow the master and slave rotating at equal or variable velocities

In an embodiment, the apparatus further includes a gear train controlled valve assembly for controlling working medium flow of the at least one expander and/or the cryogenic expander. The apparatus further includes a second gear train controlled valve assembly for controlling input of working medium intake of the at least one compressor. The gear train controlled valve assembly is preferably controlled by a stepper motor.

### ADVANTAGEOUS EFFECTS OF INVENTION

This invention aims to alleviate the problems of prior art thermal engines and to provide a gas expansion/compression force modulation mechanism. Additionally, this design offers an effective heat exchange system from high temperature region to cryogenic region, using a compact design to accomplish oxygen separation from the ambient air so that pure oxygen combustion may be used for fuel, which in return allows easy CO2 (carbon dioxide) sequestration to reduce emission.

When excessive heat energy is available relative to engine loading, this engine can store surplus heat energy into other forms of energy including compressed air, electrical in battery or hydrogen production and storage. Energy storage by this device is in the order of low density energy source to high density energy fuel.

### BRIEF DESCRIPTION OF DRAWINGS

FIG. 1

[FIG. 1] Shows a 3D illustration of the apparatus structure;

FIG. .2

[FIG. 2] Shows a perspective 3D illustration of the force modulation unit, expander and compressor as well as a top view of the force modulation unit;

[FIG. 2b] Shows a cross-sectional side view of the expander, force modulation unit and compressor;

FIG. 3

[FIG. 3] Shows an exploded view of a Torque Coupling Mechanism (TCM) as well as an exploded top view of the TCM;

FIG. 4

[FIG. 4] Shows a 3D illustration of the TCM and its break system;

FIG. 5

[FIG. 5a] [FIG. 5b] Show a side view and a top view of continuously variable transmission (CVT), and the connection between the CVT and the TCM;

FIG. 6

[FIG. 6] Shows pressure control valve system for the CVT;

FIG. 7

[FIG. 7] Shows an exploded view of a synchronous gear train controlled valves assembly for expanders, as well as its top and front views;

FIG. 8

[FIG. 8a] [FIG. 8b] [FIG. 8c] Show the gear train controlled valve assembly of the compressor;

FIG. 9

[FIG. 9] Shows an additional 3D illustration of the apparatus; and

FIG. 10

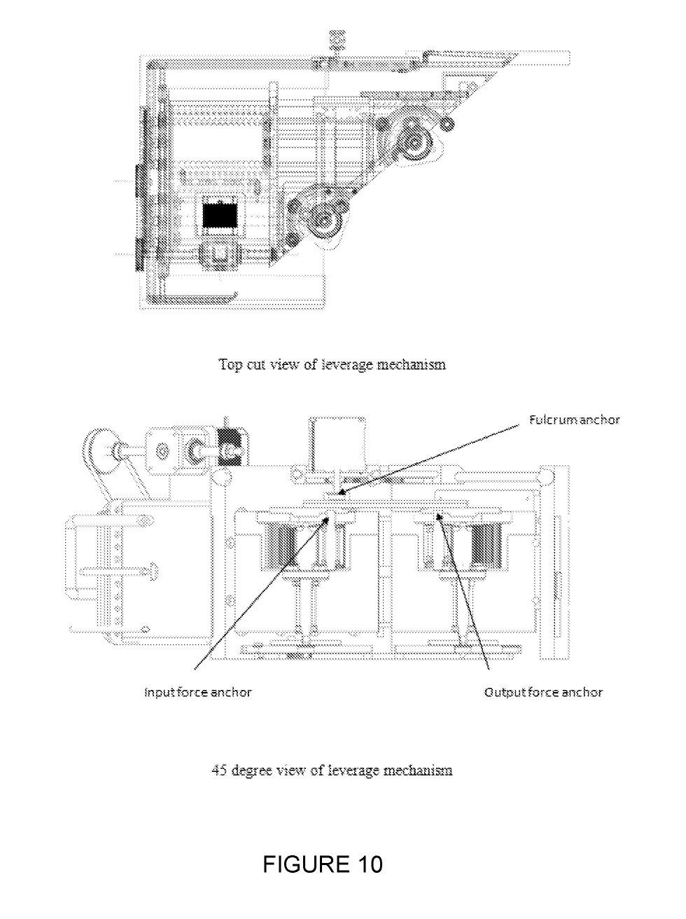

[FIG. 10] Shows a 45 degree cross-sectional view of the force modulation unit (below) and the 45 degree line drawn on top.

### DESCRIPTION OF EMBODIMENTS

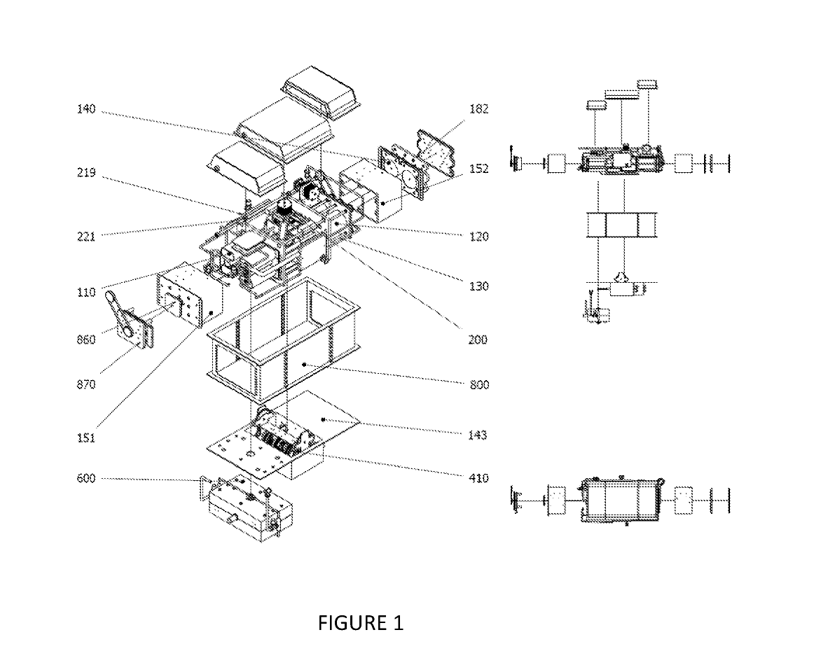

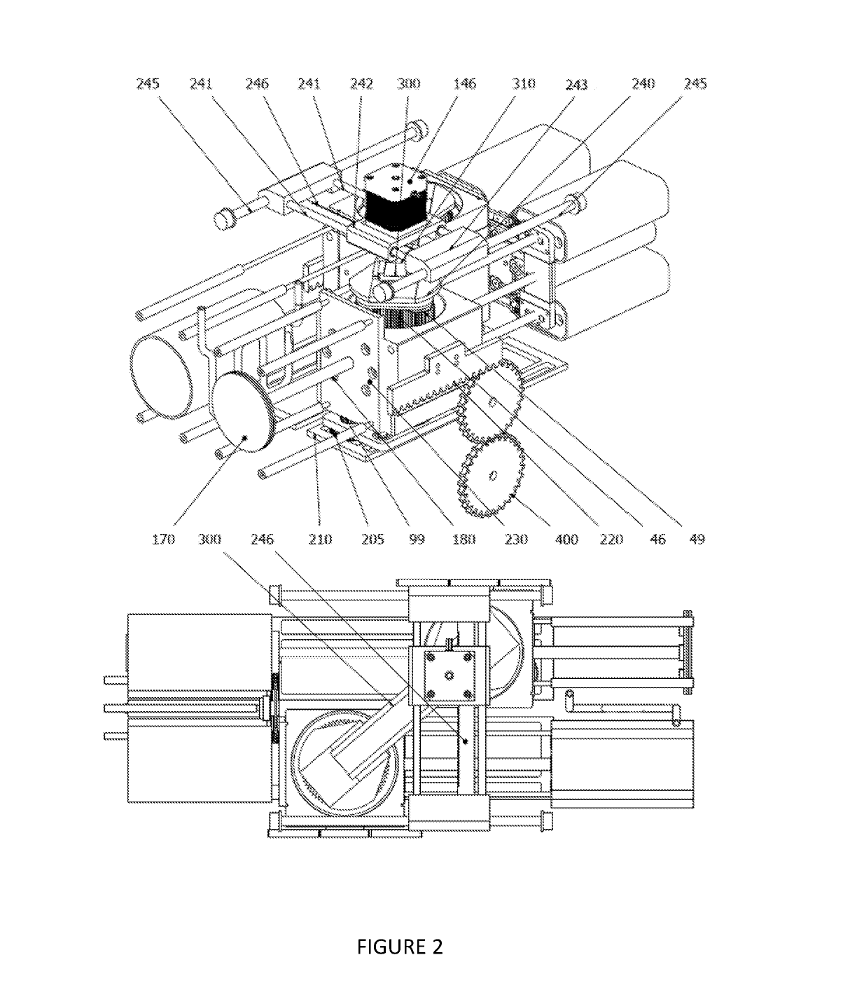

FIG. 1 shows a perspective view of the apparatus and its components in accordance with the mechanical structure and arrangement. The apparatus consists of a single or multiple stage compressor 110. The compressor 110 is cylindrical and has a thin wall of rust-resistant metal chambers where gas will be volumetrically reduced by pistons. When the gas is volumetrically reduced thermal energy is stored for each cycle of compression. In order to achieve optimum energy efficiency, the compressor 110 includes at least one pair of cylinders, each having a piston and a rod. The compressor 110 may also be comprised of a pair of compression units, each unit including a plurality of compressors for multi-staged compression. Although several configurations for the compressor 110 can be used, the embodiment described below is a two-staged compressor having two cylinders for the first stage and one cylinder for the second stage.

The compressor 110 is connected to a heat expander 120 and a cryogenic expander 130 via a force modulation unit. The force modulation unit comprises two conversion gears 200 which are described in detail in relation to FIG. 2. The heat expander 120 has a plurality of thin wall rust resistant metal chambers where highly compressed gas will volumetrically expand against piston 170 (one such piston shown in FIG. 2) whilst releasing energy. A set of dual cylinders is used as thermal expander 120. Compressor 110, thermal expander 120 and cryogenic expander 130 are made of alloy aluminum or stainless steel enforced by a steel plate body with bore holes in order to sustain high heat and/or pressure and optimum heat exchange. Compressor 110 is enclosed by a heat reservoir 151 and expander 120 is enclosed by heat reservoir 152. Heat reservoir 152 will have external heat, such as solar or geothermal heat or heat from fuel supplied continuously while reservoir 151 is fully insulated from heat exchange against ambient environment.

To correlate compression reaction force, which is the combined force from multi-stage compressors, lever 300 of the force modulation unit will modulate action force that consists of the gas expansion force from heat expander 120 and cryogenic expander 130, plus the force generated by inhaling gas body pressure within the first stage and second stage cylinders, due to the rigid connection of conversion gear 200. With proper leverage control of action force, a constant output force can be generated after deduction of compression reaction force.

Heat expander 120 and cryogenic expander 130 utilize high pressure gas supplied by compressor 110 for expansion, whereas after expansion, low pressure gas expelled from both expanders will be routed back to compressor 110 for recompression. At the initial phase of a cycle, high pressure action force from expansion units in one side will offset compression force and ejection of companion expander low pressure gas through lever 300. Initially the force required for compression and ejection is low (relative to the stage), therefore, lever 300 will compensate the unbalanced force by high leverage ratio. Through the cause of this cycle, action force will drop while reaction force will go up due to expansion and compression. To balance this force disparity, lever ratio will change accordingly. Cool gas flow from cryogenic expander 130 will absorb heat from high pressure gas body and oxygen separation from ambient air through heat exchange before recompression along with warmer gas body out of heat expander 120.

A pair of cylinders of the thermal expander 120 alternate to enable high pressure gaseous working medium supplied by compressor 110 to enter for an initially isobaric process, wherein a high temperature heat source will have close contact with the gaseous working medium. Due to increased thermal temperature, this isobaric expansion shall proportionally lengthen inside thermal expander 120. The isobaric process will be terminated when the taken quantity of high pressure working medium can finish the second stage expansion without additional input. At the end of the expansion inside thermal expander 120, the working medium pressure and temperature can be determined by a variety of factors such as its expansion duration which directly affects the length of heat absorption, or the isobaric expansion duration which determines the quantity of compressed air input, or both. It is an object of this design that at full expansion, gas temperature lowers the fluid temperature inside reservoir 152, which has lower temperature than the external heat source temperature. With such a solution, the natural temperature disparity will enable efficient heat energy flow from higher temperature region to lower temperature in heat reservoir 152, with such a solution, the natural temperature disparity will enable efficient heat energy flow from higher temperature region, which avoids the use of separate cooling components seen in most heat engines.

After expansion in the thermal expander 120, the low pressure gas will go through the pipes that routes towards heat exchange (897, 896 in FIG. 10). Because the expansion in 120 is exposed to high temperature from an external heat source, the gas body will be hot, even though it is low pressure. So the purpose of heat exchange is to eventually pass the heat towards the cold gas from the cryogenic expander 130. The cold gas from cryogenic expander 130 will firstly cool down air to separate oxygen. Then it can be used to cool down hot air from thermal expander 120. If it were done the other way around, it would not be cold enough to separate oxygen from the air. For example, if cryogen body temperature is 40 K, the thermal gas body is 350 k, while separated oxygen will be 80 to 90 k. Oxygen will be separated before cooling down the thermal gas. Because the heat is energy and may be originated from fuel or from another heat source, compressing hot gas will draw more energy. In the end, the hot and low pressure gas at the end of thermal expansion is mixed with the cold and low pressure gas body from the cryogenic expander. The more cryogenic gas there is to cool down the high temperature gas before compression, the less energy is required for compression. During compression, temperature and pressure of the gaseous working medium will increase. This makes the compression more demanding for energy. Adopting staged compression allows heat dissipation more effectively as the cryogenic expansion allows the gas to be cooled down before compression.

The variable leverage provided by the force modulating unit and its lever 300 ensures that even though the pressure inside the cylinder where thermal expansion is occurring may be lower than ambient air pressure during free expansion of gas, the leverage ratio manages to offset the pressure drop by lifting the leverage ratio, so that a net modulated expansion force can overpower pressure force from the companion cylinder. As a result, a net energy output, which is bigger than the energy required for the same amount of working medium compressed inside compressor 110 can be expected. The compressor 110 on the opposite side of an expanding expander, being rigidly connected via the force modulation unit (including two conversion gears 200 and a lever 300), will use the pressure force from the expander via the force modulation unit.

A pair of cryogenic expanders 130 alternately enable high pressure working medium supplied constantly by compressor 110 to enter for an initial adiabatic expansion, during which no heat energy will be added. An isobaric expansion in the cryogenic expander 130 shall be terminated when enough high pressure working medium can sustain adiabatic expansion for the remaining cylinder space. After cryogenic expansion, gas flow will be directed into two streams of pipe flow and further towards various thermal units 221, 219, 268 to perform heat exchange. It is also used as counter flow against low pressure gas output of thermal expander 120, and against high pressure gas flow in heat exchange. A clear advantage of this engine is that heat removal before and after compression will save energy drawn from the thermal expander 120 and cryogenic expander 130. Hereafter, gaseous working medium will be routed back to compressor 110 to engage the next cycle of compression-expansion, having its temperature elevated to a higher point due to heat exchange, while maintaining a pressure close to the gas body pressure existing in cryogenic expander 130.

A pair of cryogenic expanders 130 alternately enable high pressure working medium supplied constantly by compressor 110 to enter for an initial adiabatic expansion along with associated thermal expander 120, during which no heat energy will be added. The isobaric expansion in the cryogenic expander 130 shall be terminated when enough high pressure working medium can sustain adiabatic expansion for the remaining cylinder space. At the end of expansion, the pressure could be lower than the ambient air pressure, while the temperature will be cryogenic, for example, 30 to 40 Kelvin's. When cryogenic gas is ejected, two streams of pipes will direct this gas flow back to the compressor 110. One stream will go through heat exchange 219 and 221, which are designated as oxygen separation unit. Cryogenic gas will control heat exchange 219 temperature just below oxygen boiling point which is higher than nitrogen boiling temperature. Another cryogenic gas flow will be directed into heat exchange unit 268 to remove heat from high pressure gas flow, which is ejected from final stage of compressor 110. This design utilizes heat energy within the system instead of dumping heat into the environment. There is an efficiency advantage for internal heat removal before and after compression. It will save energy drawn from the thermal expander 120 and cryogenic expander 130.

The overall performance of the engine is dictated by the size of the engine cylinders, the working medium compression ratio, the temperature of the working medium, the external heat supplied and engine cycles. Furthermore, the entropy of the gaseous working medium can be significantly reduced with minimum work or energy required if heat removal happens simultaneously. Hence, after heat removal by low boiling temperature gases such as hydrogen, highly compressed gaseous working medium can expand adiabatically in cryogenic expander 130 to achieve cryogenic temperature after doing work along with thermal expander 120. As a result, oxygen separation from the ambient air, which enables oxygen rich combustion, and CO2 (carbon dioxide) rich liquefying are both achievable through cryogenic cooling and distillation. The gas flow out of cryogenic expander will be even lower than the liquefying temperature for N2. But by controlling the cold gas flow rate, the engine can find a thermal equilibrium in a heat exchange unit that can stabilized in the region which allows oxygen become liquid while nitrogen stays gaseous.

In this engine design, the colder gas from the cryogenic expander will be mixed back into the relatively warm thermal gas during compression. This allows for the compression to start at a lower temperature so more energy can be utilised.

The heat reservoir 152 requires an external heat supply such as a solar heat, water or a combustion unit (having an oxygen tank ready to pump oxygen). Alternatively, the system can have water electrolysis to separate hydrogen by other source of energy. For example, if a household has a PV panel in the roof, the solar energy can be stored in the hot water tank. An even more sophisticated solution would be hydrogen production by water electrolysis and then storing hydrogen in compressed form. The compressed hydrogen can be decompressed to initially release energy, then going to combustion to release heat.

FIG. 2 shows the cylinder and piston 170 of the thermal expander 120, and the first and the second stages of the compressor 100. The Force Modulation Unit (FMU) consists of two conversion gear units 200 and a lever 300 connecting the two conversion gear units 200. Piston 170 of the thermal expander 120 has a planar surface similar to what is generally used in an internal combustion engine. The piston rod 180 is a rigid metal component, which is connected to the piston at one end and to the conversion gear 200 at one end.

The Force Modulation Unit FMU consists of two epicyclic conversion gear units 200. The conversion gear units 200 are used for transferring the piston reciprocation motion into clock swinging motion having a fixed swing angle. This is done by controlling the rotation of the sun gear 46 and planet gears 49 while an annular gear remains stationary or non-rotational. Below the conversion gear 200, is a rack gear 210 that is affixed to the engine frame 800 (shown in FIG. 1). The sun gear 46 of the conversion gear 200 has a shaft connected to it extending out to the coupling pinions 205 that mate with the rack gear 210. As the piston 170 reciprocates, the stationary rack gear 210 will force the coupling pinions 205 to rotate which further tangentially rotates the sun gear 46. As a result, gas expansion reciprocation force becomes the torque force of planet gear 49, through its mating with sun gear 46. The conversion gear 200 shall be made of a very high tensile strength metal material.

Lever 300 is capable of modulating gas expansion force or gas compression force through dynamic leverage ratio control. Lever 300 is a rigid, long, and polished square steel bar, bridging a pair of neighbouring conversion gear units 200, each having their respective planet gears 49 attached to a guiding plate 240 via their shafts. The lever 300 can slide along a guiding slot with its lower plane matching lever 300 profile. Such rigid assembly guarantees that the shaft axis of the two sun gears 46 and the shaft axis of the two planetary gears 49 of two conversion gear units 200 all coincide within the same plane that is perpendicular against the guiding plate 240 of lever 300. On the upper portion of lever 300, there will be a sliding fulcrum mechanism 310, which can slide freely along lever 300.

Fulcrum 310 can slide along lever 300, with its pivot point aligned with stepper motor 146 shaft. The stepper motor 146 rests on a bracket 242 and two guiding rods 241 that are secured by another pair of brackets 240. The brackets 240 are further secured by another pair of guiding rods 245 perpendicular against the first set of guiding rods 241. The purpose of this design is to regulate the non-linear and non-constant force originated from the gas expansion cylinder 171 into a near linear and constant output force. Due to alternating action of such paired conversion gear units 200, gas expansion force from one cylinder will sequentially actuate lever 300 and coupling pinions 205 under first conversion gear unit 200, together with the sun gear 46 and the planetary gear 49. The first conversion gear unit 200 then delivers an opposite push force, via lever 300 onto a second, neighboring conversion gear unit 200. Due to dynamic leverage control, the force will be modulated into near linear, constant force.

To arbitrarily place dynamic fulcrum 310 onto a position where desirable leverage can be established, stepper motor 146 rotates its pinion against a rack gear 246, so that its shaft, which acts as the anchor point of fulcrum 310 because it is securely inserted into fulcrum 310 will move bracket 242 along guiding rods 241. The action force on lever will come from the shaft of planetary gear, which originates from the expansion force. The tooth contact in between planetary gear and sun gears will force the planetary shaft to rotate around the sun shaft axis. Such rotation is a real time tangent against lever 300 at the point where planetary shaft axis is acting on plate 240. Consequently, real time tangent force will act on pivot point, which is the shaft of stepper motor 146. Through the lever, a force will further delivered onto companion FMU 200, which is a reversal interaction throughout. Due to the pivot point being theoretically on anywhere in between the two axis of the planetary gears 49, the leverage ratio is a continuation of below positive infinity and negative infinity range, which means strong force can be leveraged down to an arbitrary lower range while weak force can be leveraged up to an arbitrary higher range. As a result, this apparatus can modulate the non-constant gas expansion force into constant force. FIGS. 2b and 10 represent a more detailed structure of fulcrum in relation to the force modulation unit 200.

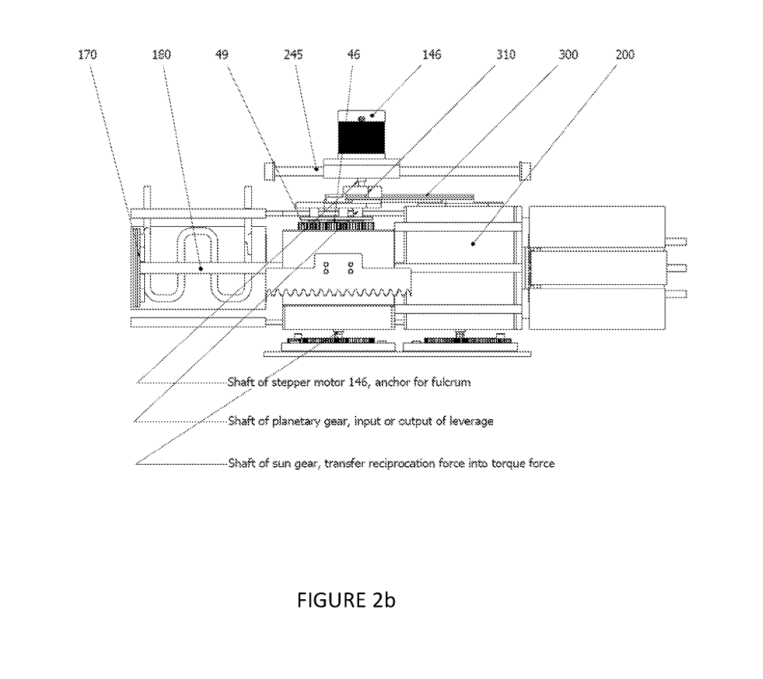

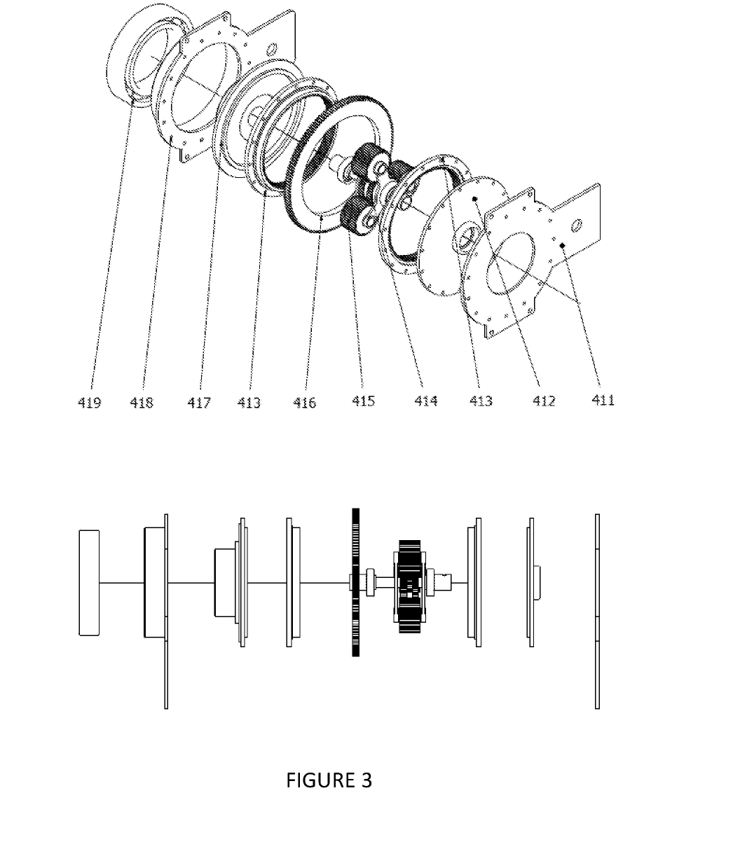

The alternating motion by the two conversion gear units 200 will couple a modulated torque force, through gear rack 220 that is fastened on the side plane of each conversion gear unit 200, and a mating gear train 400 (seen in FIG. 2), into a Torque Coupling System (TCM) 410 (shown in FIG. 1 and in more detail in FIG. 3). Gear train 400 consists of several mating spur gears in a vertical row arrangement, affixed on to engine body main frame 800 (shown in FIG. 1). Torque Coupling Mechanism 410 alternately engages or disengages torque from each respective side with a differential component 500.

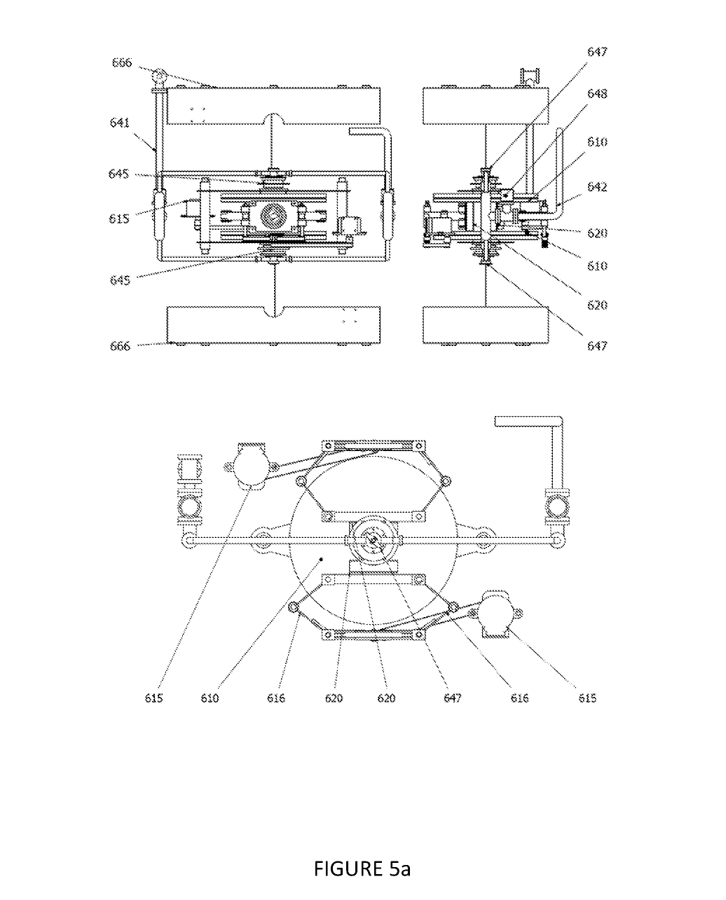

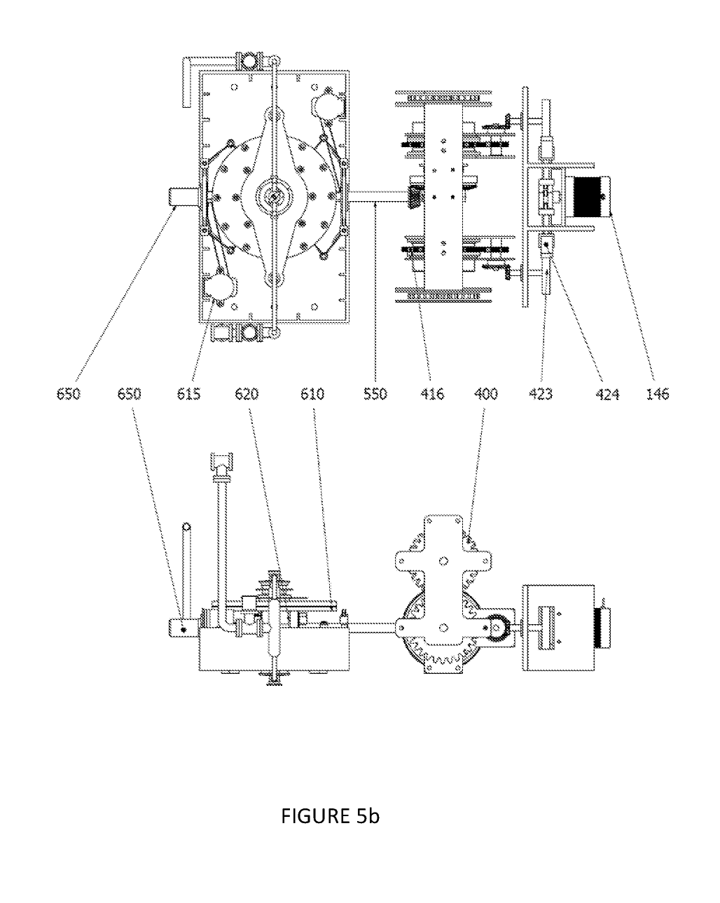

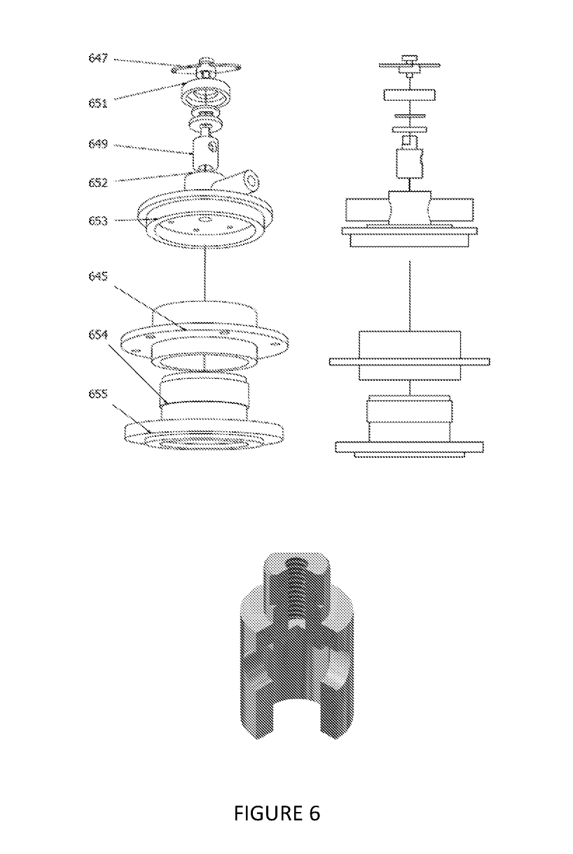

A differential gear 500 having its main axis coaxially aligned with the torque coupling mechanism 410, delivers modulated torque force to Continuously Variable Transmission (CVT) 600 through its output shaft 550 which is normally a drive shaft. Continuously Variable Transmission (CVT) 600 is shown in detail in FIG. 5. In this engine design, the drive shaft 550 becomes the output shaft of the engine.

The alternatively coupled torque force from both expanders requires an engaging and disengaging mechanism for the differential unit 500. This is provided by a pair of torque coupling mechanisms 410, one torque coupling mechanism being illustrated in detail in FIG. 3. Each torque coupling mechanism is an epicyclic gear, which is further divided into a matching pair of epicyclic gears that share the same planetary gears 415 while having its own sun gear 414 and annular gear 413. The epicyclic gear that connects to differential unit 500 will be rigidly affixed with mounting bracket 411 so it will stationary. The remaining epicyclic gear will have a different mounting bracket 417 to have annular gear 413 affixed onto through a bearing 419. Bearing 419 of the outer ring will be affixed with mounting bracket 418. The bearing 419 and its bore will have a short shaft of bracket 417 inserted, which allows annular gear 413 to have full rotation. This rotation is controlled by break ring 416, which has its bore rigidly assembled into a short shaft of the annular gear 413. When break ring 416 is stopped, a torque can be coupled. When it is released, a torque will not be engaged. This is particularly important when the torque is coming from companion expander (piston in cylinder) because its associated expander (piston in cylinder) will be in retreat, which creates a reverse motion even though the torque is zero. By disengaging break ring 416, the annular gear 413 will rotate. When this happens, the sun gears 414 will not rotate synchronously. The break ring 416 thus enables the torque coupling mechanism 410 to selectively couple torque force coming from each of the conversion gears 200.

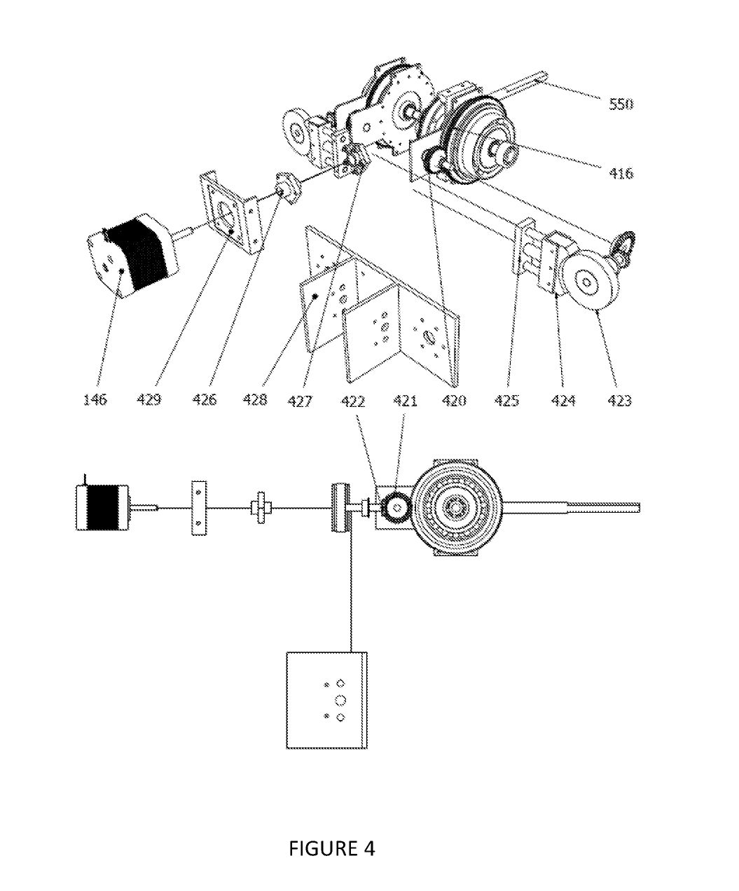

In order to achieve continuous and fast breaking for the torque coupling system, a break system illustrated in FIG. 4 will be used. Each torque coupling system 410 has a break ring 416 as shown in FIG. 3. The break ring 416 mates with a gear 420, which is coaxially arranged with spur gear 421. The spur gear 421 is further associated with a second spur gear 422, friction wheel 423, break pad 424, and displacement shoe 425. A pentagonal rotor 426, controlled by stepper motor 146, can alternately displace only one displacement shoe 425 so that if one break is on, another break will be off, which allows only the torque from the appropriate coupling to be transmitted. Due to many levels of leveraged connections, the break from friction wheel 423 can be quite strong when it is engaged.

Continuously Variable Transmission (CVT) 600 can further change the output of the engine. It can be flexibly arranged under the main engine frame 800 (shown in FIG. 1) preferably below the conversion gear 200. Differential gear 500, which is widely used in wheeled vehicles for variation of angular velocity control, can be used to switch the coupling torque originating from the alternating modulated torque force from both sides of the reciprocating cylinders. The CVT will nonetheless, maintain one rotational direction regardless where the torque coming from, with the help of the torque coupler 410 arrangement.

Referring to FIGS. 5a and 5b, Continuously Variable Transmission (CVT) 600 is a unit where a pair of two identical and large friction plates 610 is used to sandwich another pair of smaller friction wheels 620. One of the small friction wheels 620 is coaxially assembled into the long output shaft 550 as a master drive, whilst the remaining small friction wheel 620 will be the slave drive arranged coaxially into engine output shaft 650 (shown in FIG. 5b). Both friction wheels 620 can slide along their respective assembled shafts i.e. master drive with shaft 550 and slave drive with shaft 650. This is best seen in FIG. 5b which shows the configuration of TCM and the CVT in relation to one another and the output shafts. The contact point control of master and slave friction wheels 620 in relation to the large friction plates 610 pair will decide the outcome of gearing. Due to the independent control arm 616 driven by dedicated stepper motor 615, the friction wheels 620 can be positioned between the rotation axis of the large friction wheels and the edge of their circumference. The gearing ratio is determined by the physical contact positions of such paired friction wheels 620 in relation to the axis of the friction plates 610.

In order to control friction plates 610 in such narrow vertical space, a pressure actuator system is used. This system consists of a high pressure reservoir division 641 on one side and vacuum reservoir division 642 on the opposite side. Both reservoirs are linked by a pipe system onto a pair of cylinders 645 which are positioned onto the top side of the upper friction plate 610 and the bottom of the lower friction plate 610. To apply pressure from friction plates 610 onto the drive friction wheel pair 620, high pressure air from reservoir 641 is supplied to both cylinders 645 by opening lever 647 controlled valves 649 and solenoid control valve 648. As pressure is accurately regulated, solenoid valve 648 will be shut while lever 647 controlled valves 649 will be shut.

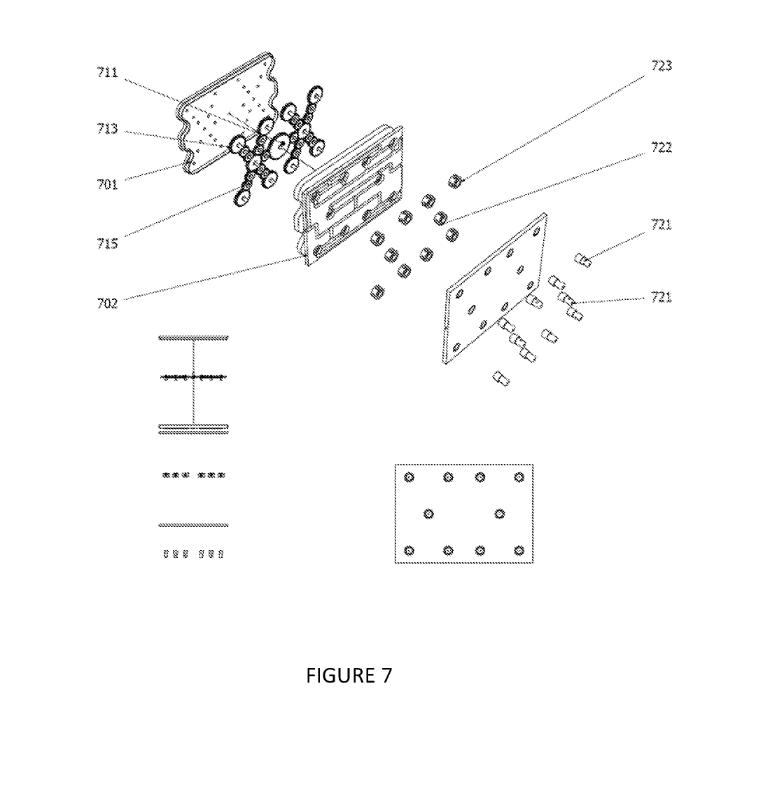

The configuration of the valve control of the cylinders 645 is shown in more detail in FIG. 7. Valve 649 has two perpendicularly arranged bores. There can be three scenarios for such design, one is engaging to high pressure reservoir, or to vacuum reservoir, or to none. When friction plate 610 must disengage, the lever 647 opens controlled valve 649 connected to the vacuum reservoir division 642, and the solenoid control valve 648 is opened to release high pressure air into the vacuum reservoir 642 so that both friction plates 610 will be forced to move away from master and slave drive wheels 620 simultaneously.

An apparatus described herein needs very precise timing control on expansion of highly compressed gas if energy efficiency is the top consideration. A plurality of valves are synchronously driven by one stepper motor through several gear train systems with the aim of having at least one valve for each expansion cylinder and at least one valve for each compression cylinder. This single stepper motor control solution for multiple valve assemblies which will be described in detail below.

FIG. 7 shows a synchronous gear train controlled valve assembly 182 for expanders 120 and 130. The valve assembly 182 is also shown in FIG. 1. The valve assembly is controlled by a stepper motor (not shown in FIG. 7) through drive gear 711, which further actuates spur gear 713, 715. There are eight spur gears 713, each controlling a valve 723 through its shaft. These eight spur gears 713 will be aligned with eight cryogenic expanders 130, as in the embodiment described herein. Similarly, there are two spur gears 713, each controlling valve 721 through its shaft. These two spur gears 713 will be aligned with two thermal expanders 120, as in the current embodiment. Rotational valve 721 is substantially cylindrical, with its valve channel penetrating the cylinder axis. The exit bore is concealed in one end while the other end opens. The concealed end will have a borehole, which allows the control gear shaft inserted into the borehole, secured by a screw. When valve 721 rotates inside the stationary valve body 723, which is for cryogenic expanders, or inside stationary valve body 722, which is for thermal expanders, all entry bores of valves 721 are precisely aligned angularly. Both valve body 722 and valve body 723 have the same entry bore, though valve body 723 will have a wider exit bore cut out of its main bore hole within which rotational valve 721 is arranged to rotate. This gives extra time for allowing more compressed air to enter cryogenic expander 130, after a precise angular rotation that will cut off compressed air supply to thermal expander 120. Further rotation from control gear train will shut compressed gas supply to cryogenic expanders 130. This will enable further expansion for both expanders with remaining gas body until all pistons reach the end of the expansion simultaneously. Compressed gas can be divided into three streams by flow control box 702, as illustrated by FIG. 7. For exit gas, due to very low pressure, the cryogenic flow will be regrouped inside 702, while gas from thermal expanders will be directed to independent pipe connection also within 702.

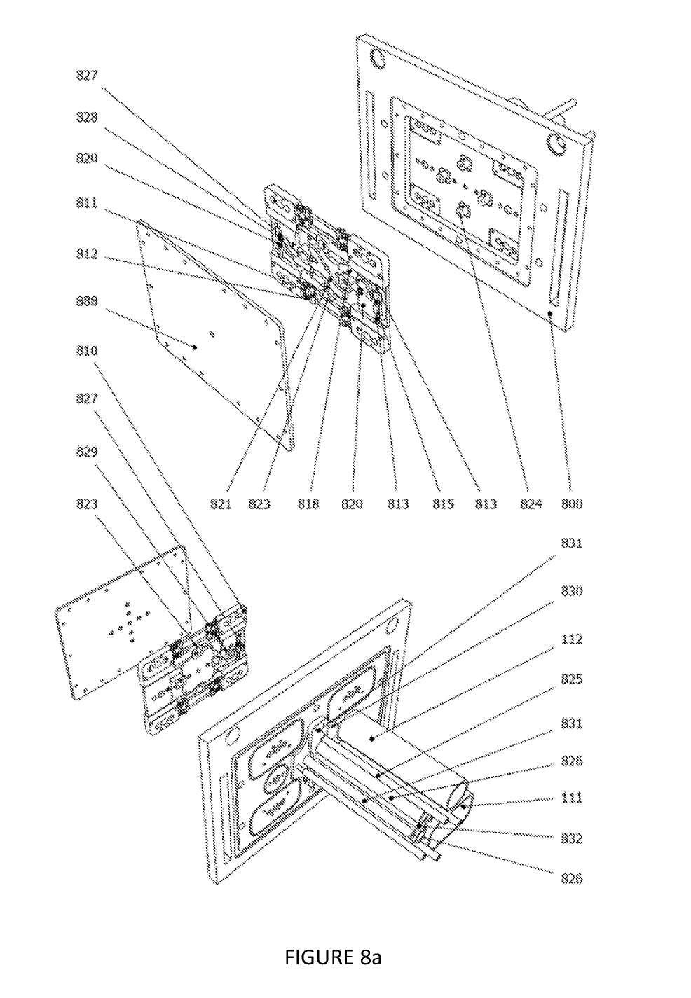

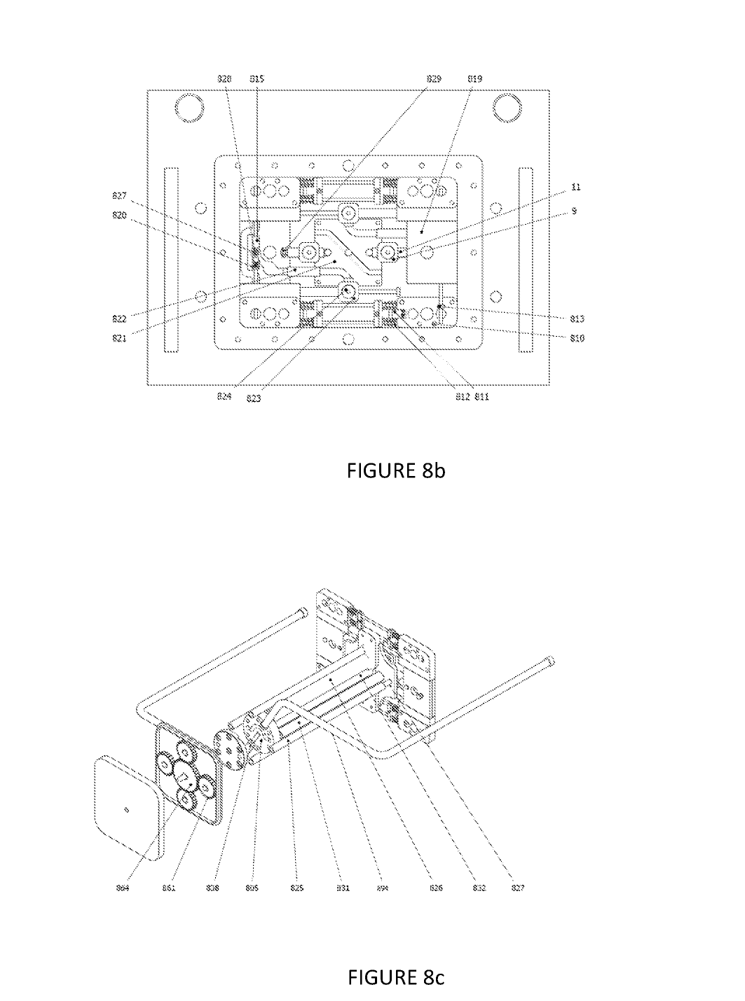

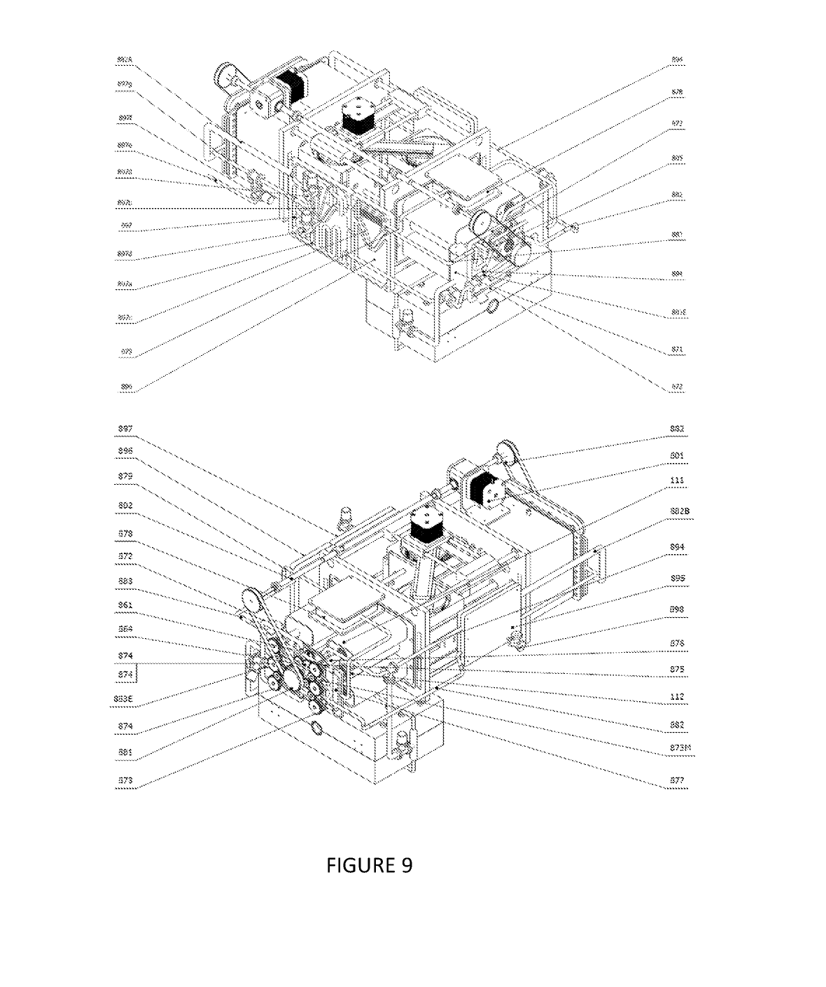

The compressor 110 has a separate gas flow control system (860, 870 in FIG. 1) which is further illustrated in FIGS. 8a, 8b, and 8c. It consists of a gear train to synchronously control a plurality of valves. A front plate 888 is a thick rectangular metal panel arranged to allow stages of compression cylinders 111, 112 to be attached onto one side. The opposite side will be carved out in a preferably rectangular geometry where components of gas flow regulation of various compression stages can be positioned. These components enable the control of different pressurized gas for entering the compression cylinders 111, 112. In the embodiment of FIGS. 8 and 9, a two stage compression is depicted. Four first stage regulator blocks 810 are each positioned in a corner of carved geometry on plate 800. The first stage regulator block 810 has uncompressed gas flow supplying the first stage cylinders 111 through pressure actuating valve 811. Valve 811 is set to shut mode by default due to spring 812 constrain. When a piston moves away from plate 800, the dropping pressure inside the first stage cylinder 111 will allow uncompressed gas force into two of the regulator blocks 810, which are associated with the same conversion gear 200. Upon compression of gas body inside cylinder 111, valve 811 is shut due to spring 812 and higher pressure in cylinder 111. Exit valve 813 is pressure sensitive having a long shaft inserted into regulator block 810 at one end and to a limiter 815 at the other end. The limiter includes a spring component 820, which sets the exit valve 813 to shut position by default. As pressure of the first stage compression is raised further, valve 813 will push both springs 820 until gas flows from both first stage compressors, merges and enters block 819 through molded channel, and connecting tube 822, and further into block 821. Similar to the expander valve design described in FIG. 7, rotating valve 824 which is inserted into stationary valve body 823, will be controlled by a shaft 825 to direct air flow into storage tube 826.

Upon second stage intake of gas from tube 826, valve 824 will be rotated into the exit bore of body 823, which is linked by a tube to redirect gas flow back to block 819, though into a second molded channel. As the internal pressure of the second stage cylinder 112 drops further, exit gate 827 which is constrained by spring 828 to shut by default will be forced open to allow gas flow from tube 822 into second stage cylinder 112. At certain displacement, pressure from tube 826 and cylinder 112 will reach equilibrium. As the second stage compression takes place in cylinder 112, gate 827 is in shut mode, which forces gas fluid to exit from gate 829 that is shut by default unless pressure inside cylinder 112 is larger. Upon such condition, gas flow will escape through a similar valve and body configuration to gain entry through connection tube 11 and stationary body 9 into exit bore in block 821, which connects to sequential heat exchange components and finally back to the expander units.

FIG. 9 shows an embodiment of the present invention with its integrated compression 110, expansion 120, 130 and force modulation 200 units. Due to the staged “pull style” compressions of the embodiment described above, there is no space to arrange a gear train at the front of panel 800 to control the gas flow for the compressor 110. Instead, a gear train box 860 and 870, as shown in FIG. 1, will be controlled by a stepper motor 801 through a long shaft 802. It also synchronously and/or simultaneously controls gear train for thermal expander 120 and cryogenic expander 130.

There are two types of compressions in compressor 110. The main compression or “pull style compression” happens in between a piston head and panel 800 which is referred to as leveraged compression because the compression comes from the lever of the force modulation unit. When the high pressure gas body in expander 120 is in its initial phase, the gas pressure in the compressors 110 are low (relative to the stages). Therefore, the lever 300 will control the expansion force by higher leverage ratio. When the cycle proceeds, the gas pressure in expander 120 will drop while the pressure in compressor 110 will go up. Also, the compressors inhaling gas happens simultaneously with the expansion in the thermal expander 120, so it becomes part of force along with expander. Another type of compression utilizes the space opposite leveraged compression chambers and will be referred as direct compression hereafter. For direct compression inside first stage cylinders 111, ambient air will have its pressure marginally increased. The ambient air goes through an initial humidity removal by desiccant 871. Ambient air is taken in through pipe 872 which is a U-shaped of metal tube, and then enters the top and bottom containers 873. Each container 873 conceals two sets of valves which consist of a stationary valve body 875 and a rotation valve 876. When one side of first stage compressor 111 pair is inhaling ambient air, the two rotation valves 876 will be in an open position, aligned with body 875 towards container 873. The remaining two rotation valves 876 will be 90 degrees offset and connected to exit at joint 877.

Pressurized air will flow into tank 878 before entering heat exchange 896 through pipe 879 for final humidity removal. From heat exchange 896 the air flows into cryogenic heat exchange in 897 to reach the temperature range where oxygen can be liquefied while nitrogen remains gaseous. Liquid oxygen can be discharged by lower tap 897d for fuel combustion. Cold, nitrogen rich air can be released from higher tap 897d and used for cooling the compressor 110 or to be used as coolant for air conditioning, and eventually released back to environment. As for direct compression inside the second stage cylinders 112, cold gas fluid from cryogenic expanders 130, after going through heat exchanges 895, 896, 897, will enter middle container 873M through pipelines 882 and 883. The direct pressure on piston during intake of gas before leveraged compression and thermal expander 120 pressure force, through rigid connection of conversion gear 200, will increase the pressure of gas body until the pressures reach equilibrium. This allows the stream of gas fluid to combine with thermal expander gas flow at pipe 894 through exit pipe 883E. Therefore, gas fluid from all expanders after expansion will reenter staged compressors through block 805 (FIG. 8c) through pipe 832 (FIG. 8a), for leveraged compression. Compression force from expanders, after modulation by lever 300, will correlate the action force when leveraged compression ratio increases.

To control gas flow entering first and second stage compressor sequentially for leveraged compression, through components inside panel 800, box 860, having four gears 861 (FIG. 8c and FIG. 9), and corresponding shaft 825 (FIG. 8a), will be driven by the main drive gear 864 (FIG. 8c). The shaft for main drive gear 864 is coaxially assembled with a second gear train 870 (FIG. 1) similar drive gear that is driven by tooth wheel 881. Tooth wheel 881 is further driven by stepper motor 801 through a timing belt. Tubes 838 (FIG. 8c), inserted into lower side of block 805 (FIG. 9), will direct uncompressed gas to enter panel 800 through another tube 832. Compressed gas will flow out of final stage compressor 112, merged in block 805 by two tubes 831 (FIGS. 8a and 8c), and then routed by tube 894 (FIG. 8c) towards expander units.

There are a few energy storage solutions in current invention. The best option takes into account energy density, storage and stability. Hydrogen production by electrolysis is widely researched. It is not a topic in this design to integrate technology that separates hydrogen by water electrolysis. In this design, an engine design is provided where heat from one heat source will power the engine operation, which can then generate electricity. If this heat source offers more energy than needed, it is possible to use the engine to generate electricity, which will split hydrogen from oxygen bond. Then the apparatus can compress and store hydrogen in a high pressure vessel by release tap 898 (FIG. 9). When more energy is required, compressed hydrogen can firstly be released as part of compression energy into mechanical energy by thermal expander 120 and cryogenic expander 130, and then the depressurized hydrogen can be released through pipe 897e into a combustion unit with pure oxygen to generate heat, which can be used by this device, while water is the final product. Alternatively, pure oxygen produced by this apparatus can burn with carbohydrate without nitrogen involved. An additional unit to cool down carbon dioxide after combustion for storage is a further option that this engine can achieve.

While specific embodiments of the present invention have been provided, it is to be understood that these embodiments are for illustration purposes and not limiting. Many additional embodiments will be apparent to persons of ordinary skill in the art reading this disclosure.

1. An apparatus for extracting thermal energy including:
at least one expander for extracting thermal energy from thermal expansion of a working medium in one or more cylinders of the at least one expander;
at least one compressor for compressing the working medium after the expansion; and
a force modulation unit connecting the at least one expander to the at least one compressor, the force modulation unit being adapted to modulate non-constant force from the at least one expander into a substantially constant force.

2. An apparatus according to claim 1, wherein the at least one expander and the at least one compressor work alternately via the force modulation unit.

3. An apparatus according to claim 1 or 2, wherein the force modulating unit includes two conversion gears, each conversion gear having at least one epicyclic gear.

4. An apparatus according to any one of claims 1 to 3, wherein the force modulating unit further includes a lever connecting the two conversion gears.

5. An apparatus according to claim 4, wherein the lever constrains a sun gear axis and a planetary gear axis of each epicyclic gear within a swinging plane.

6. An apparatus according to claim 5, wherein fulcrum of the lever is constrained by the swinging plane, the fulcrum being freely slideable along the lever in between the planetary gear axes of the conversion gears for pivotal control.

7. An apparatus according to claim 5 or 6, wherein expansion force from the at least one expander acts on the lever via the epicyclic gears of each conversion gear, through the planetary shaft axis constrained by the swinging plane, perpendicularly against the lever in real time when it is swinging around its sun gear.

8. An apparatus according to any one of claims 4 to 7, wherein the lever is adapted to modulate gas expansion force or gas compression force through a dynamic leverage ratio control in a range of smaller than infinitive and bigger than inversely infinitive.

9. An apparatus according to any one of claims 6 to 8, wherein the fulcrum of the lever is dynamically controlled by a stepper motor.

10. An apparatus according to any one of claims 4 to 9, wherein each conversion gear acts on the lever alternately for each cycle of expansion and/or compression.

11. An apparatus according to any one of claims 1 to 10, wherein energy level in a first conversion gear resulting from thermal expansion is offset by energy level in a second conversion gear using the dynamic leverage control of the lever, with a constant surplus output during each cycle.

12. An apparatus according to any one of claims 1 to 11, wherein a deficiency in thermal expansion pressure is compensated by thermal radiation from an external heat source.

13. An apparatus according to any one of claims 1 to 12, wherein compression entropy can be reduced by thermal radiation towards low temperature uncompressed working medium.

14. An apparatus according to any one of claims 1 to 13, wherein the apparatus further includes at least one cryogenic expander.

15. An apparatus according to any one of claims 1 to 14, wherein the at least one cryogenic expander is used to cool temperature of the working medium between end of thermal expansion and intake of working medium by the compressor.

16. An apparatus according to any one of claims 1 to 15, wherein working medium ejected by the at least one cryogenic expander is used to cool temperature of the working medium between end of thermal expansion and intake of working medium by the at least one compressor.

17. An apparatus according to any one of claims 1 to 16, wherein working medium ejected by the at least one cryogenic expander is used to control temperature of high pressure working medium before intake by the at least one expander.

18. An apparatus according to any one of claims 3 to 17, wherein piston displacement in one side of the at least one expander due to working medium expansion, is converted into rotary motion by the epicyclic gear of each conversion gear in the force modulation unit.

19. An apparatus according to any one of claims 4 to 18, wherein the lever, through its fulcrum, delivers a reversal and leveraged action force to overcome compression force, ejection of working medium after expansion and a net output force that is constant for the cycle.

20. An apparatus according to any one of claims 1 to 19, wherein the apparatus further includes a torque coupling mechanism for coupling torque force from the rotary motion provided by each conversion gear.

21. An apparatus according to claim 20, wherein the torque coupling mechanism includes two epicyclic gears adapted to selectively collect the torque force provided by the two epicyclic gears of the conversion gears.

22. An apparatus according to claim 20 or 21, wherein the apparatus further includes a differential unit adapted to combine two torque forces collected by the torque coupling mechanism into one directional torque output.

23. An apparatus according to any one of claims 1 to 22, wherein the apparatus further includes a continuously variable transmission unit adapted to change an output ratio.

24. An apparatus according to claim 23, wherein the continuously variable transmission unit includes a first axis and a second axis within a plane and perpendicular to one another, the first axis having an input master friction wheel and slave friction wheel rotating around it due to another pair of friction wheels sandwiching the master and slave wheels with pressure while rotating around the second axis to allow the master and slave rotating at equal or variable velocities.

25. An apparatus according to any one of claims 1 to 24, wherein the apparatus further includes a gear train controlled valve assembly for controlling working medium flow of the at least one expander and/or the cryogenic expander.

26. An apparatus according to claim 25, wherein the apparatus further includes a second gear train controlled valve assembly for controlling input of working medium intake of the at least one compressor.

27. An apparatus according to claim 25 or 26, wherein the gear train controlled valve assembly is controlled by a stepper motor.
